(19) United States
(12) Patent Application Publication
(10) Pub. No.: US 2016/0034092 A1
(43) Pub. Date: Feb. 4, 2016

(54) STACKUP FOR TOUCH AND FORCE SENSING

(71) Applicant: SYNAPTICS INCORPORATED, San Jose, CA (US)

(72) Inventors: Felix Schmitt, San Francisco, CA (US); Richard Schediwy, Union City, CA (US)

(21) Appl. No.: 14/448,587

(22) Filed: Jul. 31, 2014

(51) Int. Cl. G06F 3/041; G06F 3/044

(52) U.S. Cl. CPC G06F 3/0416; G06F 3/0414; G06F 3/044; G06F 2203/04106

(57) ABSTRACT

A device and method for operating a capacitive input device configured to sense input objects and their applied force in a sensing region, the device including a deformable substrate having an input surface; a first array of sensor electrodes; a second array of sensor electrodes; a third array of sensor electrodes positioned underneath the first and second arrays such that, in response to force applied by an input object to the input surface, at least one electrode of the first array deflects relative to the second and third arrays.

### FIELD OF THE INVENTION

This invention generally relates to electronic devices, and more specifically relates to sensor devices and using sensor devices for producing user interface inputs.

### BACKGROUND OF THE INVENTION

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

The proximity sensor device can be used to enable control of an associated electronic system. For example, proximity sensor devices are often used as input devices for larger computing systems, including: notebook computers and desktop computers. Proximity sensor devices are also often used in smaller systems, including: handheld systems such as personal digital assistants (PDAs), remote controls, and communication systems such as wireless telephones and text messaging systems. Increasingly, proximity sensor devices are used in media systems, such as CD, DVD, MP3, video or other media recorders or players. The proximity sensor device can be integral or peripheral to the computing system with which it interacts.

Some input devices also have the ability to detect applied force in addition to determining positional information for input objects interacting with a sensing region of the input device. However, presently known force/touch input devices are limited in their ability to accurately determine the position and/or intensity at which force is applied. This limits the flexibility and usability of presently known force enabled input devices. An improved force enhanced input device is thus needed in which the position and/or intensity of the applied force may be precisely determined.

### BRIEF SUMMARY OF THE INVENTION

Embodiments of the present invention provide a device and method that facilitates device usability through the use of an sensor stack-up characterized by a first layer of receiver electrodes separated from a second layer of receiver electrodes and a layer of transmitter electrodes by a compliant layer, where both layers of receiver electrodes carry a mixed touch/force signal. By separating the touch and force information from the two mixed channels, both a position estimate and a force estimate may be obtained for input objects interacting with the sensing region.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary electronic system that includes an input device and a processing system in accordance with an embodiment of the invention;

FIG. 2 is a schematic view of an exemplary processing system in accordance with an embodiment of the invention;

FIG. 3 is a cross section view of a sensor stack-up including a first layer of receiver sensor electrodes on a top surface of a compliant layer, and a second layer of receiver sensor electrodes coplanar with a layer of transmitter sensor electrodes on an opposite side of the compliant layer in accordance with an embodiment of the invention;

FIG. 4 is a top view of the second layer of sensor electrodes and layer of transmitter sensor electrodes of FIG. 3 in accordance with an embodiment of the invention;

FIG. 5 is a plot of signal strength versus input object distance from the touch surface for exemplary first and second receiver sensor electrode layers in accordance with an embodiment of the invention;

FIG. 6 is a perspective view of an alternate embodiment of a sensor stack-up generally analogous to that shown in FIG. 3, but with the second layer of receiver sensor electrodes separated from the layer of transmitter sensor electrodes by an inelastic layer in accordance with an embodiment of the invention;

FIG. 7 is a top view of the stack-up of FIG. 6, showing a staggered configuration of the first layer of receiver sensor electrodes relative to the second layer of receiver sensor electrodes in accordance with an embodiment of the invention; and

FIG. 8 is a flow chart depicting an exemplary process of determining touch and force information for an input object interacting with a sensing region in accordance with an embodiment of the invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

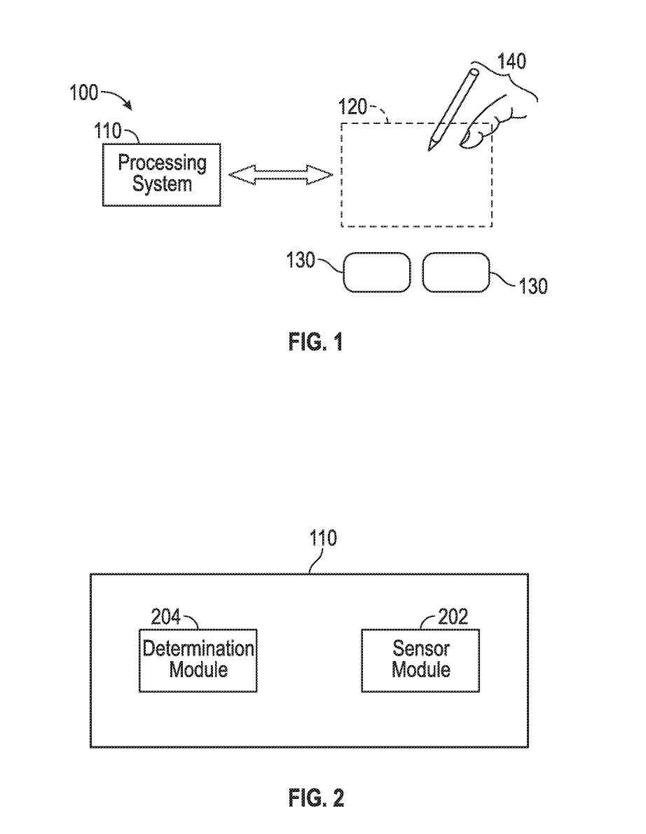

Turning now to the figures, FIG. 1 is a block diagram of an exemplary input device 100 in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In a preferred embodiment, the input device 100 is implemented as a force enabled touchpad system including a processing system 110 and a sensing region 120. Sensing region 120 (also often referred to as “touchpad”) is configured to sense input provided by one or more input objects 140 in the sensing region 120. Example input objects include fingers, thumb, palm, and styli. The sensing region 120 is illustrated schematically as a rectangle; however, it should be understood that the sensing region may be of any convenient form and in any desired arrangement on the surface of and/or otherwise integrated with the touchpad.

Sensing region 120 may encompass any space above (e.g., hovering), around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device is adapted to provide user interface functionality by facilitating data entry responsive to the position of sensed objects and the force applied by such objects. Specifically, the processing system is configured to determine positional information for objects sensed by a sensor in the sensing region. This positional information can then be used by the system to provide a wide range of user interface functionality. Furthermore, the processing system is configured to determine force information for objects from measures of force determined by the sensor(s). This force information can then also be used by the system to provide a wide range of user interface functionality, for example, by providing different user interface functions in response to different levels of applied force by objects in the sensing region. Furthermore, the processing system may be configured to determine input information for more than one object sensed in the sensing region. Input information can be based upon a combination the force information, the positional information, the number of input objects in the sensing region and/or in contact with the input surface, and a duration the one or more input objects is touching or in proximity to the input surface. Input information can then be used by the system to provide a wide range of user interface functionality.

The input device is sensitive to input by one or more input objects (e.g. fingers, styli, etc.), such as the position of an input object within the sensing region. The sensing region encompasses any space above, around, in and/or near the input device in which the input device is able to detect user input (e.g., user input provided by one or more input objects). The sizes, shapes, and locations of particular sensing regions may vary widely from embodiment to embodiment. In some embodiments, the sensing region extends from a surface of the input device in one or more directions into space until signal-to-noise ratios prevent sufficiently accurate object detection. The distance to which this sensing region extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device, contact with an input surface (e.g. a touch surface) of the input device, contact with an input surface of the input device coupled with some amount of applied force, and/or a combination thereof. In various embodiments, input surfaces may be provided by surfaces of casings within which the sensor electrodes reside, by face sheets applied over the sensor electrodes or any casings.

The electronic system 100 may utilize any combination of sensor components and sensing technologies to detect user input (e.g., force, proximity) in the sensing region 120 or otherwise associated with the touchpad. The input device 102 comprises one or more sensing elements for detecting user input. As several non-limiting examples, the input device 100 may use capacitive, elastive, resistive, inductive, magnetic, acoustic, ultrasonic, and/or optical techniques.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

It should also be understood that the input device may be implemented with a variety of different methods to determine force imparted onto the input surface of the input device. For example, the input device may include mechanisms disposed proximate the input surface and configured to provide an electrical signal representative of an absolute or a change in force applied onto the input surface. In some embodiments, the input device may be configured to determine force information based on a defection of the input surface relative to a conductor (e.g. a display screen underlying the input surface). In some embodiments, the input surface may be configured to deflect about one or multiple axis. In some embodiments, the input surface may be configured to deflect in a substantially uniform or non-uniform manner. In various embodiments, the force sensors may be based on changes in capacitance and/or changes in resistance.

In FIG. 1, a processing system 110 is shown as part of the input device 100. However, in other embodiments the processing system may be located in the host electronic device with which the touchpad operates. The processing system 110 is configured to operate the hardware of the input device 100 to detect various inputs from the sensing region 120. The processing system 110 comprises parts of or all of one or more integrated circuits (ICs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as graphical user interface (GUI) actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions. The types of actions may include, but are not limited to, pointing, tapping, selecting, clicking, double clicking, panning, zooming, and scrolling. Other examples of possible actions include an initiation and/or rate or speed of an action, such as a click, scroll, zoom, or pan.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information, particularly regarding the presence of an input object in the sensing region. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

Likewise, the term “force information” as used herein is intended to broadly encompass force information regardless of format. For example, the force information can be provided for each input object as a vector or scalar quantity. As another example, the force information can be provided as an indication that determined force has or has not crossed a threshold amount. As other examples, the force information can also include time history components used for gesture recognition. As will be described in greater detail below, positional information and force information from the processing systems may be used to facilitate a full range of interface inputs, including use of the proximity sensor device as a pointing device for selection, cursor control, scrolling, and other functions.

Likewise, the term “input information” as used herein is intended to broadly encompass temporal, positional and force information regardless of format, for any number of input objects. In some embodiments, input information may be determined for individual input objects. In other embodiments, input information comprises the number of input objects interacting with the input device.

In some embodiments, the input device 100 is implemented with additional input components that are operated by the processing system 110 or by some other processing system. These additional input components may provide redundant functionality for input in the sensing region 120, or some other functionality. For example, buttons (not shown) may be placed near the sensing region 120 and used to facilitate selection of items using the input device 102. Other types of additional input components include sliders, balls, wheels, switches, and the like. Conversely, in some embodiments, the input device 100 may be implemented with no other input components.

In some embodiments, the electronic system 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

It should also be understood that the input device may be implemented with a variety of different methods to determine force imparted onto the input surface of the input device. For example, the input device may include mechanisms disposed proximate the input surface and configured to provide an electrical signal representative of an absolute or a change in force applied onto the input surface. In some embodiments, the input device may be configured to determine force information based on a defection of the input surface relative to a conductor (e.g. a display screen underlying the input surface). In some embodiments, the input surface may be configured to deflect about one or multiple axis. In some embodiments, the input surface may be configured to deflect in a substantially uniform or non-uniform manner.

As described above, in some embodiments some part of the electronic system processes information received from the processing system to determine input information and to act on user input, such as to facilitate a full range of actions. It should be appreciated that some uniquely input information may result in the same or different action. For example, in some embodiments, input information for an input object comprising, a force value F, a location X,Y and a time of contact T may result in a first action. While input information for an input object comprising a force value F′, a location X′,Y′ and a time of contact T′ (where the prime values are uniquely different from the non-prime values) may also result in the first action. Furthermore, input information for an input object comprising a force value F, a location X′,Y and a time of contact T′ may result in a first action. While the examples below describe actions which may be performed based on input information comprising a specific range of values for force, position and the like, it should be appreciated that that different input information (as described above) may result in the same action. Furthermore, the same type of user input may provide different functionality based on a component of the input information. For example, different values of F, X/Y and T may result in the same type of action (e.g. panning, zooming, etc.), that type of action may behave differently based upon said values or other values (e.g. zooming faster, panning slower, and the like).

As noted above, the embodiments of the invention can be implemented with a variety of different types and arrangements of capacitive sensor electrodes for detecting force and/or positional information. To name several examples, the input device can be implemented with electrode arrays that are formed on multiple substrate layers, typically with the electrodes for sensing in one direction (e.g., the “X” direction) formed on a first layer, while the electrodes for sensing in a second direction (e.g., the “Y” direction are formed on a second layer. In other embodiments, the sensor electrodes for both the X and Y sensing can be formed on the same layer. In yet other embodiments, the sensor electrodes can be arranged for sensing in only one direction, e.g., in either the X or the Y direction. In still another embodiment, the sensor electrodes can be arranged to provide positional information in polar coordinates, such as “r” and “θ” as one example. In these embodiments the sensor electrodes themselves are commonly arranged in a circle or other looped shape to provide “θ”, with the shapes of individual sensor electrodes used to provide “r”.

Also, a variety of different sensor electrode shapes can be used, including electrodes shaped as thin lines, rectangles, diamonds, wedge, etc. Finally, a variety of conductive materials and fabrication techniques can be used to form the sensor electrodes. As one example, the sensor electrodes are formed by the deposition and etching of conductive ink on a substrate.

In some embodiments, the input device is comprises a sensor device configured to detect contact area and location of a user interacting with the device. The input sensor device may be further configured to detect positional information about the user, such as the position and movement of the hand and any fingers relative to an input surface (or sensing region) of the sensor device.

In some embodiments, the input device is used as an indirect interaction device. An indirect interaction device may control GUI actions on a display which is separate from the input device, for example a touchpad of a laptop computer. In one embodiment, the input device may operate as a direct interaction device. A direct interaction device controls GUI actions on a display which underlies a proximity sensor, for example a touch screen. There are various usability differences between indirect and direct more which may confuse or prevent full operation of the input device. For example, an indirect input device may be used to position a cursor over a button by moving an input object over a proximity sensor. This is done indirectly, as the motion of the input does not overlap the response on the display. In a similar case, a direct interaction device may be used to position a cursor over a button by placing an input object directly over or onto the desired button on a touch screen.

Referring now to FIGS. 1 and 2, the processing system 110 includes a sensor module 202 and a determination module 204. Sensor module 202 is configured to operate the sensors associated with the input device 100 and sensing region 120. For example, the sensor module 202 may be configured to transmit sensor signals and receive resulting signals from the sensors associated with sensing region 120. Determination module 204 is configured to process data (e.g. the resulting signals) and to determine positional information and force information for input objects interacting with the sensing region 120. The embodiments of the invention can be used to enable a variety of different capabilities on the host device. Specifically, it can be used to enable cursor positioning, scrolling, dragging, icon selection, closing windows on a desktop, putting a computer into sleep mode, or perform any other type of mode switch or interface action.

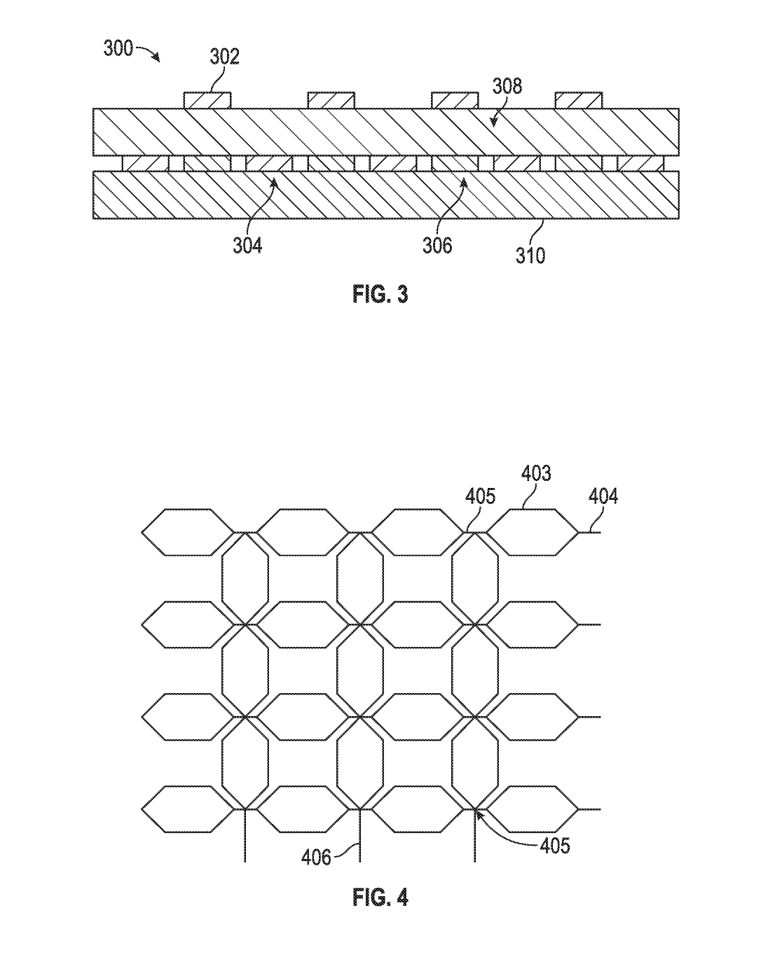

Referring now to FIG. 3, an input device 300 includes a first array of sensor electrodes disposed in layer 302. The first array of sensor electrodes comprises receiver sensor electrodes disposed on or near a top surface of a pliable component 308. A second array of sensor electrodes disposed in layer 304 comprises receiver sensor electrodes disposed on an opposing side of the pliable component 308. A third array of sensor electrodes disposed in layer 306, the same plane as the second array of sensor electrodes 304, comprises, transmitter sensor electrodes. The first receiver layer 302 and the second receiver layer 304 may each be configured to interact with the transmitter layer 306 to perform “trans-capacitive” sensing to determine both the position of and force applied by input objects in the sensing region, as described in greater detail below.

In some embodiment, jumpers may be used in order to avoid ohmic contact between the receiver electrode layer 304 and the transmitter electrode layer 306. In particular and with momentary reference to FIG. 4, a second array of receiver electrodes in layer 404 may comprise a row of electrode segments 403 connected by jumpers 405. The jumpers 405 are disposed on top of an insulator (not shown) in the region of overlap with sensor electrodes 406. Therefore, the second layer of sensor electrodes 404 and a third layer of sensor electrodes 406 occupy substantially the same plane while avoiding ohmic contact between them.

The compliant (or compressible) layer 308 may be implemented as a closed cell or open cell foam structure, or any other chemical composition and/or mechanical construction which exhibits transient elastic deformation in response to applied pressure.

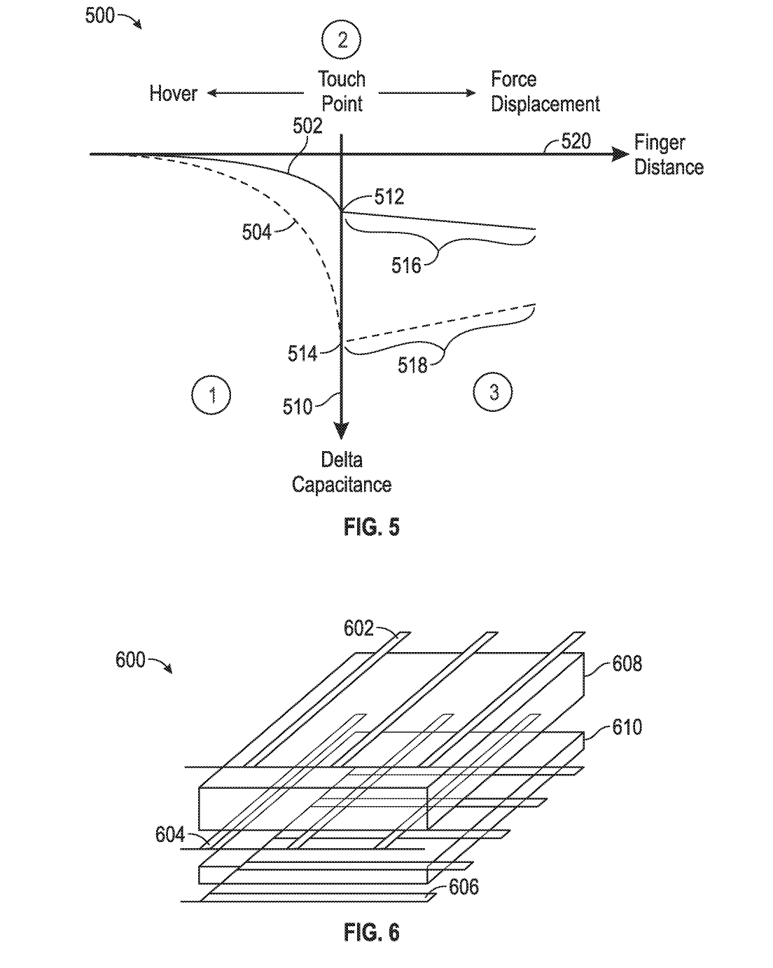

FIG. 5 is a plot 500 of signal strength (axis 510) versus input object distance from the touch surface (axis 520) for a first receiver electrode layer (signal 502) and a second receiver sensor electrode layer (signal 504). More particularly, the approach of a finger to and contact with an input surface may be graphically divided into two regions: approach (region 1), and press (region 3), separated by the touch point (2). In region 1, the finger is not yet contacting the input surface but the finger is interacting with the sensing region of the input device. In region 1, the finger is located at different distances to the two receiver electrode layers, the signal measured by electrodes in each array will have a different strength. The touch point (2) in the plot 500 depicts the finger touching the input surface without depressing it (See point 512 of signal 502, and point 514 of signal 502).

Press region 3 represents the finger pressing the compliant layer 308 downwards (negative distance to the touch pad surface). As the finger further conforms to the touch pad with increased pressure, segment 518 of signal 504 has a decreasing value, because the greater finger surface increasingly leaches field lines from the capacitive coupling between the receivers 304 and transmitters 306. As shown in segment 516 of signal 502, however, there is a competing effect to the increased finger conformance to the pad surface: the distance between the receivers 302 and the transmitters 306 decreases due to compression of the elastic medium (compliant layer 308). This effect causes the signal 502 in region 3 (corresponding to segment 516) to change opposite in sign as compared to the increasing finger conformance. Those skilled in the art will appreciate that the various components may be configured so that the decreased distance between the receivers 302 and the transmitters 306 (in the localized area surrounding the applied force) dominates the effects due to finger conformance.

In accordance with various embodiments, the sensor electrode layers 302 and 304 are configured to receive a signal which includes both effect from both touch (i.e. presence of an input object in the sensing region) and force (i.e. pressure applied by an input object onto the input surface).

In general, the two receiver layers 302, 304 can be configured such that the variable capacitance signal from both is very similar for light touches (regions 1 and 2 in FIG. 5). Accordingly, both signals channels may be used to determine position information in a straightforward manner. Moreover, by combining or otherwise processing the signals 502 and 504, the force information for input objects in the sensing region may also be determined.

In principle, the touch (t) and force (f) frame data can be obtained from the two mixed signal channels by a linear equation system such as

t=a1*Rx1+a2*Rx2

f=b1*Rx1+b2*Rx2

where Rx1 corresponds to signal 502, Rx2 corresponds to signal 504, and a1, a2, b1, and b1 are coefficients; alternatively, more sophisticated (e.g., higher order) models with enhanced touch and force separation and accuracy may be employed.

FIG. 6 is an alternate embodiment of a sensor stack-up generally analogous to that shown in FIG. 3, but with the second layer of receiver sensor electrodes separated from transmitter sensor electrodes by an inelastic layer. More particularly, an input device 600 includes a first array 602 of receiver sensor electrodes disposed on or near a top surface of a pliable component 608, a second array 604 of receiver sensor electrodes disposed on an opposing side of the pliable component 608, and a third array 606 of transmitter sensor electrodes disposed below an inelastic (e.g., rigid) layer 610 separating the second array 604 and the third array 606.

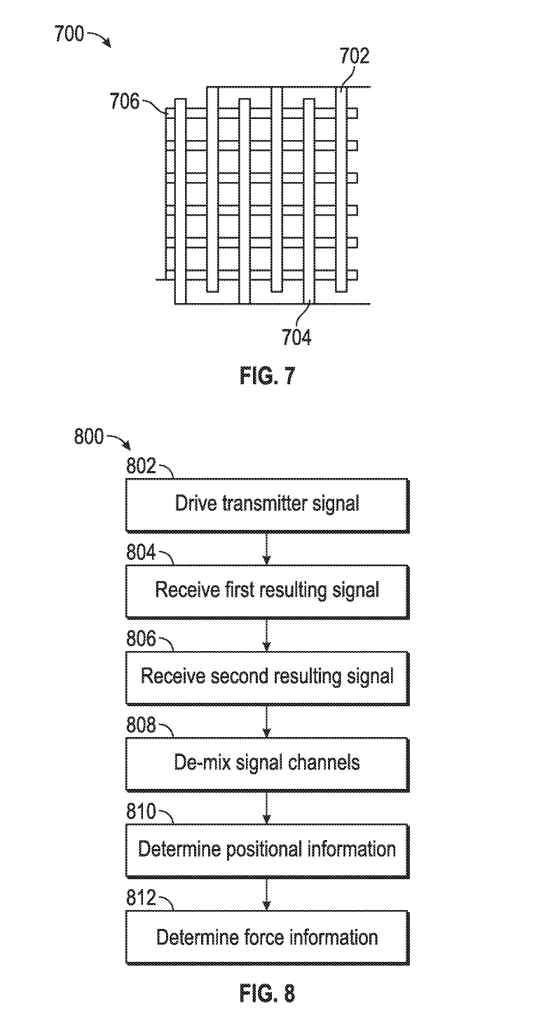

FIG. 7 is a top view of the stack-up of FIG. 6, showing an alternative embodiment comprising a staggered configuration of the second array of receiver sensor electrodes relative to the third array comprising transmitter sensor electrodes. More particularly, an input device 700 includes a first array 702 of receiver sensor electrodes, a second array 704 of receiver sensor electrodes, and an array 706 of transmitter electrodes, showing an interleaved alignment of the first and second receiver arrays. In various embodiments, such an arrangement allows a high degree of positional resolution, while reducing the number of electrodes needed to determine force and position information.

FIG. 8 is a flow chart of a method 800 of operating electronic systems of the type associated with the devices shown in FIGS. 1-7 in accordance with various embodiments. Method 800 includes driving a transmitter signal (Task 802) onto one or more sensing electrodes of a first array of electrodes, and receiving a first resulting signal on a second array of sensor electrodes (Task 804), where the first resulting signal includes effects of a change in distance between at least one electrode from the second array and at least one transmitter electrode of the first array. The method 800 also includes receiving a second resulting signal on a third array of sensor electrodes (Task 806), where the second resulting signal includes effects of a change in distance between an input object and at least one electrode of the third array.

The method 800 further involves separating the force and positional information from the mixed signals (Task 808), and determining positional information (Task 810) and force information (Task 812) for an input object in the sensing region. De-mixing the signal channels may be implemented by combining or otherwise processing the first and second resulting signals, for example based on a first linear relationship between the positional information and the first and second signals, and further based on a second linear relationship between the force information and the first and second signals.

A capacitive input device configured to sense input objects in a sensing region is thus provided. The input device includes: a deformable substrate having an input surface; a first array of sensor electrodes; a second array of sensor electrodes; a third array of sensor electrodes positioned underneath the first and second arrays such that, in response to force applied by an input object to the input surface, at least one electrode of the first array deflects relative to the second and third arrays. The input device also includes a processing system communicatively coupled to the first, second and third arrays of sensor electrodes and configured to: drive a sensing signal on at least one electrode of the third array; receive, from at least one electrode of the first array, a first resulting signal comprising effects of input object presence in a sensing region of the input device and effects of a change in distance between the at least one electrode from the first array and at least one electrode from the third array; and receive, from at least one electrode of the second array, a second resulting signal comprising effects of input object presence in the sensing region and effects of a change in distance between the input object and at least one electrode of the second array.

In an embodiment, the second and third arrays are disposed on a second substrate such that the relative positions between the electrodes of the second array and the electrodes of the third array remain substantially constant in response to applied force.

In an embodiment, the second and third arrays are separated by a substantially rigid substrate. Alternatively, the second and third arrays may be substantially coplanar.

In an embodiment, the electrodes of the first array are substantially parallel to and substantially overlap the electrodes of the second array.

In an embodiment, respective electrodes of the first array are substantially parallel to and interposed between respective electrodes of the second array.

In an embodiment, the third array is substantially orthogonal to at least one of the first and second arrays.

In an embodiment, the electrodes of the first array are spaced apart from one another by a first pitch, and the electrodes of the second array are spaced apart from one another by a second pitch, where the first pitch may or may not be approximately equal to the second pitch.

In an embodiment, the first resulting signal comprises a variable capacitance based on a change in the transcapacitive coupling between at least one electrode from the first array and the at least one sensor electrode from the third array in response to: i) input object presence the sensing region; and ii) a change in distance between the at least one sensor electrode of the first array and the at least one electrode of the third array.

In an embodiment, the second resulting signal comprises a variable capacitance based on a change in transcapacitive coupling between the at least one electrode from the second array and the at least one sensor electrode from the third array in response to input object presence in the sensing region.

In an embodiment, in response to applied force by an input object: the first variable capacitance changes magnitude in a first direction; and the second variable capacitance changes magnitude in a second direction different than the first direction.

In an embodiment, one of the first and second resulting signals increases, and the other of the first and second resulting signals decreases, in response to applied force by an input object.

In an embodiment, both the first and second resulting signals change magnitude in the same direction in response to an input contacting the input device.

In an embodiment, the first resulting signal is non-monotonic and the second resulting signal is monotonic.

In an embodiment, the processing system may be configured to determine positional information for an input object based on at least one of the first and second resulting signals.

In an embodiment, the processing system may be configured to determine force information for an input object based on at least one of the first and second resulting signals.

In an embodiment, the processing system may be configured to determine position and force information for an input object based on a mathematical transformation involving the first and second resulting signals.

An input device is also provided, the input comprising: an input surface; a first array of sensor electrodes and a second array of sensor electrodes separated by a deformable substrate proximate the input surface; a third array of sensor electrodes, wherein the deformable substrate and the first, second, and third arrays are configured such that in response to force applied to the input surface by an input object: i) the second array to maintains a fixed spatial relationship relative to the third array; and ii) at least one electrode of the first array deflects toward at least one electrode of the third array.

The input device may also include a processing system communicatively coupled to the first, second and third arrays of sensor electrodes and configured to: drive a sensing signal on at least one electrode of the third array; receive, from at least one electrode of the first array, a first resulting signal comprising effects of the input object in a sensing region of the input device and effects of a change in distance between the at least one electrode from the first array and at least one electrode from the third array; receive, from at least one electrode of the second array, a second resulting signal comprising effects of an input object in the sensing region and effects of a change in distance between the input object and at least one electrode of the second array; and determine positional information and force information for the input object from the first and second resulting signals.

A processing system is provided for use with an input device of the type including first and second arrays of receiver electrodes separated by a compliant layer, and a third array of transmitter electrodes configured such that in response to applied force: i) the first array locally deflects toward the third array; and ii) the second array remains substantially fixed relative to the third array. The processing system may be configured to: drive a sensing signal on the third array; receive a first resulting signal on the first array comprising effects of the local deflection of the first array; receive a second resulting signal on the second array comprising effects of a change in distance between the input object and the second array; and determine positional and force information for the input object based on the first and second resulting signals.

The embodiments and examples set forth herein are presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Other embodiments, uses, and advantages of the invention will be apparent to those skilled in art from the specification and the practice of the disclosed invention.

What is claimed is:

1. An input device comprising:
a deformable substrate having an input surface;
a first array of sensor electrodes;
a second array of sensor electrodes;
a third array of sensor electrodes positioned underneath the first and second arrays such that, in response to force applied by an input object to the input surface, at least one electrode of the first array deflects relative to the second and third arrays; and
a processing system communicatively coupled to the first, second and third arrays of sensor electrodes and configured to:
drive a sensing signal on at least one electrode of the third array;
receive, from at least one electrode of the first array, a first resulting signal comprising effects of input object presence in a sensing region of the input device and effects of a change in distance between the at least one electrode from the first array and at least one electrode from the third array; and
receive, from at least one electrode of the second array, a second resulting signal comprising effects of input object presence in the sensing region and effects of a change in distance between the input object and at least one electrode of the second array.

2. The input device of claim 1, wherein the second and third arrays are disposed on a second substrate such that the relative positions between the electrodes of the second array and the electrodes of the third array remain substantially constant in response to applied force.

3. The input device of claim 1, wherein the second and third arrays are separated by a substantially rigid substrate.

4. The input device of claim 1, wherein the second and third arrays are substantially coplanar.

5. The input device of claim 1, wherein the electrodes of the first array are substantially parallel to and substantially overlap the electrodes of the second array.

6. The input device of claim 1, wherein respective electrodes of the first array are substantially parallel to and interposed between respective electrodes of the second array.

7. The input device of claim 1, wherein the third array is substantially orthogonal to at least one of the first and second arrays.

8. The input device of claim 1, wherein the electrodes of the first array are spaced apart from one another by a first pitch, and the electrodes of the second array are spaced apart from one another by a second pitch.

9. The input device of claim 1, wherein the first pitch is approximately equal to the second pitch.

10. The input device of claim 1, wherein the first resulting signal comprises a variable capacitance based on a change in the transcapacitive coupling between at least one electrode from the first array and the at least one sensor electrode from the third array in response to: i) input object presence the sensing region; and ii) a change in distance between the at least one sensor electrode of the first array and the at least one electrode of the third array.

11. The input device of claim 1, wherein the second resulting signal comprises a variable capacitance based on a change in transcapacitive coupling between the at least one electrode from the second array and the at least one sensor electrode from the third array in response to input object presence in the sensing region.

12. The input device of claim 11 wherein, in response to applied force by an input object:
the first variable capacitance changes magnitude in a first direction; and
the second variable capacitance changes magnitude in a second direction different than the first direction.

13. The input device of claim 1, wherein one of the first and second resulting signals increases, and the other of the first and second resulting signals decreases, in response to applied force by an input object.

14. The input device of claim 1, wherein both the first and second resulting signals change magnitude in the same direction in response to an input contacting the input device.

15. The input device of claim 1, wherein the first resulting signal is non-monotonic and the second resulting signal is monotonic.

16. The input device of claim 1, wherein the processing system is configured to determine positional information for an input object based on at least one of the first and second resulting signals.

17. The input device of claim 1, wherein the processing system is configured to determine force information for an input object based on at least one of the first and second resulting signals.

18. The input device of claim 1, wherein the processing system is configured to determine position and force information for an input object based on a mathematical transformation involving the first and second resulting signals.

19. An input device comprising:
an input surface;
a first array of sensor electrodes and a second array of sensor electrodes separated by a deformable substrate proximate the input surface;
a third array of sensor electrodes, wherein the deformable substrate and the first, second, and third arrays are configured such that in response to force applied to the input surface by an input object: i) the second array to maintains a fixed spatial relationship relative to the third array; and ii) at least one electrode of the first array deflects toward at least one electrode of the third array in; and
a processing system communicatively coupled to the first, second and third arrays of sensor electrodes and configured to:
drive a sensing signal on at least one electrode of the third array;
receive, from at least one electrode of the first array, a first resulting signal comprising effects of the input object in a sensing region of the input device and effects of a change in distance between the at least one electrode from the first array and at least one electrode from the third array;
receive, from at least one electrode of the second array, a second resulting signal comprising effects of an input object in the sensing region and effects of a change in distance between the input object and at least one electrode of the second array; and
determine positional information and force information for the input object from the first and second resulting signals.

20. A processing system for use with an input device of the type including first and second arrays of receiver electrodes separated by a compliant layer, and a third array of transmitter electrodes configured such that in response to applied force: i) the first array locally deflects toward the third array; and ii) the second array remains substantially fixed relative to the third array, the processing system configured to:
drive a sensing signal on the third array;
receive a first resulting signal on the first array comprising effects of the local deflection of the first array;
receive a second resulting signal on the second array comprising effects of a change in distance between the input object and the second array; and
determine positional and force information for the input object based on the first and second resulting signals.
